(19) United States
(12) Patent Application Publication
(10) Pub. No.: US 2026/0077427 A1
(43) Pub. Date: Mar. 19, 2026

(54) MULTI-LIGHT-SOURCE CALIBRATION METHOD, LASER PROCESSING DEVICE, NUMERICAL CONTROL DEVICE AND COMPUTING SYSTEM

(71) Applicant: MAKEBLOCK CO., LTD., Shenzhen (CN)

(72) Inventors: Qinbin DAI, Shenzhen (CN); Hengkuan HUANG, Shenzhen (CN); Weihua ZOU, Shenzhen (CN)

(73) Assignee: MAKEBLOCK CO., LTD., Shenzhen (CN)

(21) Appl. No.: 19/393,277

(22) Filed: Nov. 18, 2025

Related U.S. Application Data
(63) Continuation of application No. PCT/CN2024/106007, filed on Jul. 17, 2024.

(30) Foreign Application Priority Data
May 18, 2023 (CN) 202310567666.4
May 17, 2024 (CN) 202410618472.7
May 17, 2024 (CN) 202410618474.6

(51) Int. Cl. B23K 26/035; B23K 26/042

(52) U.S. Cl. CPC B23K 26/035; B23K 26/042

(57) ABSTRACT

A multi-light-source calibration method is provided. A first pattern is produced on a processing object by using a first light source, a first coordinate system is established on the processing object, and coordinate values of the first pattern in the first coordinate system are determined. A coordinate mapping relationship between the first coordinate system and a predetermined image coordinate system is constructed. A second pattern is produced on the processing object by using a second light source, and coordinate values of the second pattern in the first coordinate system are obtained. A galvanometer parameter of a laser processing device is adjusted based on the coordinate mapping relationship, to cause coordinate values of an identical image in an identical coordinate system to remain consistent when the identical image is produced separately by using the first light source and by using the second light source.

### CROSS-REFERENCE TO RELATED APPLICATIONS

The present application is a continuation of PCT application PCT/CN2024/106007, filed on Jul. 17, 2024, which claims priority to Chinese Patent Application No. 202410618474.6, filed on May 17, 2024, and to Chinese Patent Application 202410618472.7, filed on May 17, 2024 and to Chinese Patent Application No. 202310567666.4, filed on May 18, 2023, all of which are incorporated herein by reference in their entireties.

### TECHNICAL FIELD

The present disclosure relates to the technical field of laser printing, and in particular to a multi-light-source calibration method, a laser processing device, a numerical control device, and a computing system.

### BACKGROUND

Currently, most laser processing devices use a single light source. Limited by the inherent characteristics of the light source, the laser processing devices generally fail to adapt to diverse application scenarios. Even if two types of light sources are used to operate on a same focal plane, differences in the wavelengths of the light sources lead to differences in reflection paths and angles.

As a result, coordinate systems, corresponding to the light sources, on the focal plane fail to coincide, exhibiting various coordinate differences such as rotation, distortion, scaling, and translation between the coordinate systems corresponding to the light sources, and thus resulting in a poor overlay effect for images produced by different light sources.

### SUMMARY

A multi-light-source calibration method, a laser processing device, a numerical control device, and a computing system are provided according to the present disclosure, to enhance processing quality in multi-light-source laser processing.

A multi-light-source calibration method is provided. The method includes:
producing a first pattern on a processing object by using a first light source, establishing a first coordinate system on the processing object, and determining coordinate values of the first pattern in the first coordinate system;
constructing a coordinate mapping relationship between the first coordinate system and a predetermined image coordinate system;
producing a second pattern on the processing object by using a second light source, and obtaining coordinate values of the second pattern in the first coordinate system; and
adjusting a galvanometer parameter of a laser processing device based on the coordinate mapping relationship, the coordinate values of the first pattern in the first coordinate system, and the coordinate values of the second pattern in the first coordinate system, to cause coordinate values of an identical image in an identical coordinate system to remain consistent when the identical image is produced separately by using the first light source and by using the second light source.

A multi-light-source calibration method is provided. The method includes:
determining emission positions of a first light source and a second light source, and determining reflection paths of a first optical path and a second optical path based on the emission positions, where the first optical path is a path corresponding to the first light source and the second optical path is a path corresponding to the second light source;
adjusting first optical elements in the first optical path and the second optical path to cause the reflection paths of the first optical path and the second optical path to be in a first state, where the first state indicates that the first optical path is parallel to the second optical path; and
adjusting second optical elements in the first optical path and the second optical path to cause the first optical path and the second optical path to be in a second state, where the second state indicates that focal points of exit beams in the first optical path and the second optical path lie on a first plane.

A laser processing device is provided, which includes multiple processing light sources and a multi-light-source calibration apparatus. The multi-light-source calibration apparatus is configured to perform the multi-light-source calibration method provided according to any embodiment of the present disclosure.

A numerical control device is provided, which includes multiple lasers, multiple beam expanders, reflectors, a galvanometer, a field lens, and a control system. The multiple lasers are configured to emit optical beams. The multiple beam expanders are arranged at light-emitting ports of the multiple lasers and configured to adjust beam diameters of the optical beams emitted from the multiple lasers. The reflectors are configured to reflect the optical beams emitted from the multiple lasers. The galvanometer is configured to reflect the optical beams reflected by the reflectors onto scanning areas. The field lens is located below the galvanometer and configured to focus the optical beams reflected by the galvanometer onto a processing plane. The control system is electrically connected to the multiple lasers and configured to control the numerical control device to perform the method provided according to any embodiment of the present disclosure.

A computing system applied to laser processing is provided. The computing system includes at least one numerical control device and at least one processor. The at least one processor is configured to perform the multi-light-source calibration method provided according to any embodiment of the present disclosure. The at least one numerical control device is configured to send a laser processing signal and adjust an optical path based on an instruction issued by the at least one processor.

A computer-readable storage medium is provided. The computer-readable storage medium stores a program instruction. The program instruction is executed by a processor to perform the multi-light-source calibration method according to the embodiments described above.

A computing system applied to laser processing is provided. The computing system includes at least one processor, a computer-readable storage medium, and a program instruction stored on the computer-readable storage medium. The program instruction is executed by the at least one processor, and the computing system is configured to perform the multi-light-source calibration method according to the embodiments described above.

In the technical solutions provided according to embodiments of the present disclosure, a first pattern is produced on a processing object by using a first light source, a first coordinate system is established on the processing object, and coordinate values of the first pattern in the first coordinate system are determined. A coordinate mapping relationship between the first coordinate system and a predetermined image coordinate system is constructed. A galvanometer parameter of a laser processing device is adjusted based on the coordinate mapping relationship, to cause coordinate values of an identical image in an identical coordinate system to remain consistent when the identical image is produced separately by using the first light source and by using the second light source. According to the present disclosure, with the first coordinate system as a reference coordinate system, coordinate values corresponding to both the first light source and the second light source are determined based on the first coordinate system to maintain the consistency of the coordinate system, ensuring the uniformity of the coordinate values corresponding to various light sources when switching between operational light sources. In the technical solutions provided according to the embodiments of the present disclosure, emission positions of the first light source and the second light source are determined, and reflection paths of a first optical path and a second optical path are determined based on the emission positions. After controlling the reflection paths of the first optical path and the second optical path to be in a first state, second optical elements in the reflection paths of the first optical path and the second optical path are adjusted to cause the first optical path and the second optical path to be in a second state. In this way, processing ranges of the light sources are identical, and a processing object can be processed by using multiple light sources without incurring ghosting. When switching between different light sources, scanning areas are calibrated based on corresponding parameters without recalibrating focal points, thereby ensuring processing precision. According to the embodiments of the present disclosure, the coordinate systems corresponding to the first light source and the second light source are unified, and the scanning areas are calibrated, ensuring processing quality in multi-light-source laser processing.

### BRIEF DESCRIPTION OF THE DRAWINGS

The drawings to be used in the descriptions of the embodiments of the present disclosure are described briefly as follows, so that technical solutions according to the embodiments of the present disclosure may become clearer. Apparently, the drawings in the following descriptions only illustrate some embodiments of the present disclosure. For those skilled in the art, other drawings may be obtained based on these drawings without creative work.

FIG. 1 shows a flowchart of a multi-light-source calibration method according to an embodiment of the present disclosure.

FIG. 2 is a schematic diagram showing a first pattern printed by using a first light source and a first coordinate system.

FIG. 3 is a schematic diagram showing the process of generating the first coordinate system on a second pattern.

FIG. 4 shows a flowchart of a multi-light-source calibration method according to an embodiment of the present disclosure.

FIG. 5 is a schematic diagram showing focal positions in a first optical path and in a second optical path according to an embodiment of the present disclosure.

FIG. 6 is a schematic diagram showing scanning ranges of the first optical path and the second optical path according to an embodiment of the present disclosure.

FIG. 7 shows a schematic structural diagram of a numerical control device according to an embodiment of the present disclosure.

### REFERENCE NUMERALS ARE EXPLAINED AS FOLLOWS

100: First pattern,
100-X: X-axis of first coordinate system,
100-Y: Y-axis of first coordinate system,
100-A: First positioning point on first pattern,
100-C: Second positioning point on first pattern,
100-B: Third positioning point on first pattern,
200: Second pattern,
200-X: X-axis on second pattern,
200-Y: Y-axis on second pattern,
200-A: First positioning point on second pattern,
200-C: Second positioning point on second pattern,
200-B: Third positioning point on second pattern,
400: Control system,
500: Beam expander,
410: Laser,
420: Reflector,
430: Dichroic mirror,
440: Galvanometer,
450: Field lens.

### DETAILED DESCRIPTION

Exemplary embodiments are now described more comprehensively with reference to the accompanying drawings. However, the examples of implementations may be implemented in multiple forms, and it is not to be understood as being limited to the examples described herein. Conversely, the implementations are provided to make the present disclosure more comprehensive and complete, and comprehensively convey the idea of the examples of the implementations to those skilled in the art.

In addition, the described characteristics, structures, or features may be combined in one or more embodiments in any appropriate manner. In the following descriptions, a lot of specific details are provided to give a comprehensive understanding of the embodiments of the present disclosure. However, those skilled in the art are to be aware that, the technical solutions in the present disclosure may be implemented without one or more of the particular details, or another method, unit, device, or step may be used. In other cases, well-known methods, devices, implementations, or operations are not shown or described in detail, in order to avoid obscuring aspects of the present disclosure.

The block diagrams in the drawings show merely functional entities and do not necessarily correspond to physically independent entities. In other words, such functional entities may be implemented in the form of software, or implemented in one or more hardware modules or integrated circuits, or implemented in different networks and/or processor devices and/or microcontroller devices.

The flowcharts shown in the drawings are merely for exemplary descriptions and do not necessarily include all of the content and operations/steps, nor are they necessarily performed in the sequence described. For example, some operations/steps may be further divided, and some operations/steps may be combined or partially combined. Therefore, an actual execution sequence may be changed according to an actual situation.

It should be noted that although the steps of the method in the present disclosure are described in a specific order in the accompanying drawings, this does not require or imply that the steps have to be performed in the specific order, or all the steps shown have to be performed to achieve an expected result. Additionally or alternatively, some steps may be omitted, multiple steps may be combined into a single step, and/or one step may be decomposed to multiple steps.

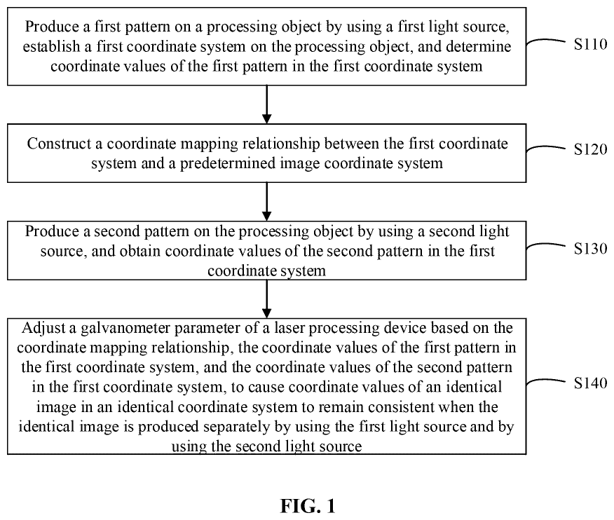

In an embodiment, FIG. 1 shows a schematic flowchart of a multi-light-source calibration method according to the embodiment of the present disclosure. As shown in FIG. 1, the multi-light-source calibration method includes the following steps S110 to S140.

In S110, a first pattern is produced on a processing object by using a first light source, a first coordinate system is established on the processing object, and coordinate values of the first pattern in the first coordinate system are determined.

In an embodiment, the first pattern is produced by a laser processing device on the processing object using the first light source, and mark points for establishing the first coordinate system are selected in the first pattern. After the first coordinate system is established, the coordinate values of the first pattern are stored by taking the first coordinate system as a reference.

The coordinate values of the first pattern refer to position information of the first pattern on the processing object, and the position information is determined by using the first coordinate system as a reference.

In S120, a coordinate mapping relationship between the first coordinate system and a predetermined image coordinate system is constructed.

In an embodiment, the predetermined image coordinate system is provided in an operating terminal of the laser processing device. For example, a computer, tablet, or cell phone that is connected to and communicates with the laser processing device may be configured to manipulate the laser processing device, and a graphical user interface of the computer, tablet, or cell phone may be used to preview a to-be-produced pattern. A preview image usually corresponds to a coordinate system, that is, the predetermined image coordinate system, and the predetermined image coordinate system may be used to display a position of a processing pattern on a processing object.

However, a preview position displayed on the operating terminal may be different from a position during actual processing. To ensure the accuracy of the position of the processing pattern during processing, the laser processing device is adjusted based on the mapping relationship between the first coordinate system and the predetermined image coordinate system during laser processing to ensure the processing quality.

In S130, a second pattern is produced on the processing object by using a second light source, and coordinate values of the second pattern in the first coordinate system are obtained.

In an embodiment, similar to the step of producing the first pattern on the processing object by using the first light source, the second pattern is produced on the processing object by switching to the second light source, and the first coordinate system is established on the second pattern to obtain the coordinate values of the second pattern in the first coordinate system.

In the above embodiments, the first pattern and the second pattern may each be a rectangular pattern, a varied regular pattern, or an irregular pattern.

The first pattern and the second pattern may be patterns with an identical shape, or patterns with different shapes.

The processing object may be paper, wooden boards, acrylic materials, and the like, in various colors.

In S140, a galvanometer parameter of a laser processing device is adjusted based on the coordinate mapping relationship, the coordinate values of the first pattern in the first coordinate system, and the coordinate values of the second pattern in the first coordinate system, to cause coordinate values of an identical image in an identical coordinate system to remain consistent when the identical image is produced separately by using the first light source and by using the second light source.

In an embodiment, after the coordinate mapping relationship between the first coordinate system and the predetermined image coordinate system is constructed, the galvanometer parameter of the laser processing device is adjusted based on the coordinate mapping relationship and the coordinate values of the first pattern in the first coordinate system during laser processing by using the first light source, and the galvanometer parameter of the laser processing device is adjusted based on the coordinate mapping relationship and the coordinate values of the second pattern in the first coordinate system during laser processing by using the second light source.

When producing the pattern on the processing object, it is to calibrate the coordinate values to ensure that the coordinate positions correspond to actual requirements in a case of using different light sources.

The first light source and the second light source operate at different wavelengths, resulting in different coordinate mappings on the processing object. Therefore, one of the first light source and the second light source is used as a positioning reference. In the embodiments, the mark points for generating the coordinate system are obtained based on the first light source, and thus the first coordinate system is established. The coordinate values of the first pattern and the second pattern in the first coordinate system are respectively obtained, so that both the first light source and the second light source use the first coordinate system as the reference coordinate system, and the uniformity of the processing coordinates is ensured even switching between the first light source and the second light source. Therefore, ghosting is avoided when the identical pattern is produced by using multiple light sources, significantly enhancing processing quality in multi-light-source laser processing.

According to the present disclosure, a first pattern is produced on a processing object by using a first light source, a first coordinate system is established on the processing object, and coordinate values of the first pattern in the first coordinate system are determined. A coordinate mapping relationship between the first coordinate system and a predetermined image coordinate system is constructed. A second pattern is produced on the processing object by using a second light source, and coordinate values of the second pattern in the first coordinate system are obtained.

A galvanometer parameter of a laser processing device is adjusted based on the coordinate mapping relationship, the coordinate values of the first pattern in the first coordinate system, and the coordinate values of the second pattern in the first coordinate system, to cause coordinate values of an identical image in an identical coordinate system to remain consistent when the identical image is produced separately by using the first light source and by using the second light source.

According to the present disclosure, with the first coordinate system as a reference coordinate system, coordinate values corresponding to both the first light source and the second light source are determined based on the first coordinate system to maintain the consistency of the coordinate system, ensuring the uniformity of the coordinate values corresponding to various light sources when switching between operation light sources, and thereby avoiding produced image blurring and enhancing processing quality in multi-light-source laser processing.

Further, in S110, the producing a first pattern on a processing object by using a first light source, establishing a first coordinate system on the processing object, and determining coordinate values of the first pattern in the first coordinate system includes the following steps S111 to S115.

In S111, a first positioning point and a second positioning point are identified from the first pattern.

In S113, a third positioning point is determined based on the first positioning point and the second positioning point, where the third positioning point is located on a straight line determined by the first positioning point and the second positioning point.

In S115, the first coordinate system is generated based on the first positioning point, the second positioning point, and the third positioning point, and the coordinate values of the first pattern in the first coordinate system are determined.

In an embodiment, taking the first pattern being a rectangular pattern as an example, both the first positioning point and the second positioning point are located on an edge of the first pattern. For example, the first pattern is a rectangular pattern, the first positioning point may be located at the leftmost position of the rectangular pattern, and the second positioning point may be located at the rightmost position of the rectangular pattern. The x-axis of the first coordinate system is determined based on the first positioning point and the second positioning point.

The third positioning point is determined in a center area of the rectangular pattern and is located on the x-axis. The third positioning point is located at a midpoint of the first positioning point and the second positioning point on the x-axis, and the third positioning point is an intersection point of the x-axis and the y-axis. The first coordinate system is established based on the x-axis and the y-axis on the first pattern.

Taking the first pattern being a circular pattern as an example, the first positioning point and the second positioning point are located on an outer edge of the circular pattern. The x-axis is determined based on the first positioning point and the second positioning point, and the third positioning point is determined based on a center of the circular pattern.

Further, in S115, the generating the first coordinate system based on the first positioning point, the second positioning point, and the third positioning point, and determining the coordinate values of the first pattern in the first coordinate system includes the following steps S1151 to S1155.

In S1151, a first axis of the first coordinate system is generated based on the first positioning point and the second positioning point.

In S1153, centered at the third positioning point, a second axis perpendicular to the first axis is generated, and the first coordinate system is obtained based on the first axis and the second axis.

In S1155, the coordinate values of the first pattern in the first coordinate system are determined based on the first coordinate system.

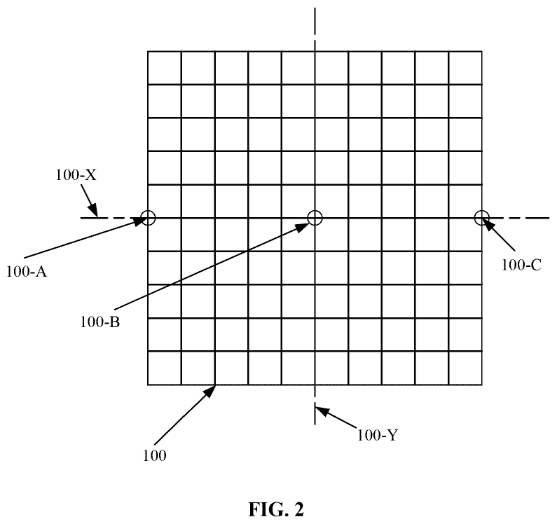

Taking the first pattern being a rectangular pattern as an example, FIG. 2 is a schematic diagram showing a first pattern and a first coordinate system.

The first positioning point 100-A and the second positioning point 100-C are located on an outer edge of the first pattern 100, and the third positioning point 100-B is located at a midpoint of the first positioning point 100-A and the second positioning point 100-C.

A connecting line determined by the first positioning point 100-A and the second positioning point 100-C is determined as the x-axis, and a straight line passing through the third positioning point and intersecting the x-axis is determined as the y-axis.

The first axis is the x-axis and the second axis is the y-axis.

The process of determining the coordinate values of the first pattern in the first coordinate system is implemented via a visual acquisition tool, which is not limited. The visual acquisition tool includes a sensor or a camera mounted on the processing device.

In addition, the coordinate values of the first pattern in the first coordinate system may be obtained by manual measurement or a measurement scanner.

Further, in S120, the constructing a coordinate mapping relationship between the first coordinate system and a predetermined image coordinate system includes the following steps S121 to S123.

In S121, coordinate values of the predetermined image coordinate system are obtained, and a difference between coordinate values of the first coordinate system and the coordinate values of the predetermined image coordinate system is determined.

In S123, the coordinate mapping relationship between the first coordinate system and the predetermined image coordinate system is constructed based on the difference.

In an embodiment, a correspondence between the two coordinate systems is determined based on the coordinate values of the first coordinate system and the coordinate values of the predetermined image coordinate system.

For example, a predetermined number of mark points are determined in the predetermined image coordinate system and the first coordinate system, coordinate values of the predetermined number of mark points in the predetermined image coordinate system and coordinate values of the predetermined number of mark points in the first coordinate system are respectively obtained, a difference between the two groups of coordinate values is calculated, and the coordinate mapping relationship between the first coordinate system and the predetermined image coordinate system is determined based on the difference.

In S130, the obtaining coordinate values of the second pattern in the first coordinate system includes the following steps S131 to S135.

In S131, the first positioning point, the second positioning point, and the third positioning point are generated on the second pattern by using the first light source.

In S133, the first coordinate system is generated on the second pattern based on the first positioning point, the second positioning point, and the third positioning point.

In S135, the coordinate values of the second pattern in the first coordinate system are obtained based on the first coordinate system.

In an embodiment, the coordinate values of the second pattern in the first coordinate system are obtained, the first light source and the second light source determine the first coordinate system as a position reference, and the coordinate mapping relationship between the first coordinate system and the predetermined image coordinate system is established. The coordinate values corresponding to the first light source or the second light source are calibrated based on the uniform reference, achieving the objective of multi-light-source processing and enhancing the processing quality.

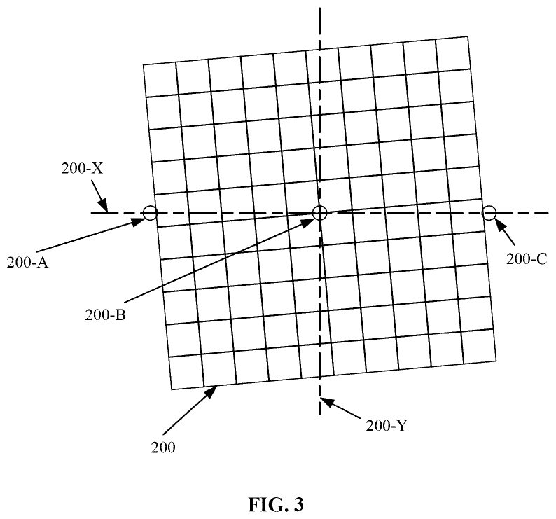

Taking the second pattern being a rectangular pattern as an example, FIG. 3 is a schematic diagram showing the process of generating the first coordinate system on the second pattern.

The first pattern in FIG. 2 and the second pattern in FIG. 3 are only schematic, and a style or size of the first pattern or the second pattern should not be limited.

In an embodiment, the coordinate values of the positioning points for establishing the first coordinate system by using the first light source are obtained, the positioning points with the identical coordinate values are generated on the second pattern by using the first light source, and the first coordinate system is generated on the second pattern, to obtain the coordinate values of the second pattern in the first coordinate system.

Further, the coordinate values of the second pattern in the first coordinate system are obtained via the visual acquisition tool, where the visual acquisition tool includes a sensor or a camera mounted on the processing device.

In an embodiment, the coordinate values of the second pattern in the first coordinate system may be obtained by manual measurement or a measurement scanner.

In FIG. 3, the first positioning point 200-A and the second positioning point 200-C are located on an outer edge of the second pattern 200, and the third positioning point 200-B is located at a midpoint of the first positioning point 200-A and the second positioning point 200-C.

A connecting line determined by the first positioning point 200-A and the second positioning point 200-C is determined as the x-axis, and a straight line passing through the third positioning point and intersecting the x-axis is determined as the y-axis.

The positions of the first positioning point, the second positioning point, and the third positioning point on the second pattern are consistent with those of the first positioning point, the second positioning point, and the third positioning point on the first pattern, but sizes and positions of an image printed on the processing objects by using the first light source and the second light source may differ due to their different wavelengths.

To maintain the consistency between the positioning points on the first pattern and the positioning points on the second pattern, the position of the processing object remains unchanged. Further, in S140, the adjusting a galvanometer parameter of a laser processing device based on the coordinate mapping relationship, the coordinate values of the first pattern in the first coordinate system, and the coordinate values of the second pattern in the first coordinate system includes the following steps S141 to S147.

In S141, a first adjustment parameter is obtained based on the coordinate mapping relationship and the coordinate values of the first pattern in the first coordinate system.

In S143, a second adjustment parameter is obtained based on the coordinate mapping relationship and the coordinate values of the second pattern in the first coordinate system.

In S145, the galvanometer parameter of the laser processing device is adjusted based on the first adjustment parameter when producing by using the first light source.

In S147, the galvanometer parameter of the laser processing device is adjusted based on the second adjustment parameter when producing by using the second light source.

The steps S141 to S143 are suitable for producing on a processing object by using the first light source of the laser processing device. The steps S145 to S147 are suitable for producing on a processing object by using the second light source of the laser processing device.

It should be noted that the galvanometer parameter of the laser processing device is obtained based on the coordinate mapping relationship and the coordinate values corresponding to the respective light source in the first coordinate system, and a position correspondence between an actual coordinate system and the predetermined image coordinate system is obtained based on the coordinate mapping relationship and the coordinate values corresponding to the respective light source in the first coordinate system. The actual coordinate system and the predetermined image coordinate system are unified, to cause the coordinate values of the identical image in the identical coordinate system to remain consistent when the identical image is produced separately by using the first light source and by using the second light source.

It can be understood that the galvanometer of the laser processing device corresponds to the predetermined image coordinate system, which represents a theoretical coordinate system. The first coordinate system represents an actual coordinate system when producing by using the first light source or the second light source.

Due to different wavelengths, the first light source and the second light source should be mounted at different positions in the laser processing device, and optical beams from the first light source and the second light source should be physically combined through an optical element. However, mounting tolerances of the light sources introduce beam-combining errors after the optical beams pass through the optical element, causing a relative relation, such as rotation, displacement and the like, between the first pattern and the second pattern.

That is, the first pattern does not coincide with the second pattern when they are placed in an overlapping pattern, leading to ghosting in the produced patterns.

In the embodiments, both the first light source and the second light source use the first coordinate system as the reference coordinate system. Even if the wavelengths of different light sources are different and there is a deviation between the produced patterns on the processing objects, the galvanometer parameter is adjusted based on the coordinate mapping relationship, to cause the processing positions on the processing objects when producing by using the first light source or the second light source to be identical to the positions displayed in the predetermined image coordinate system, avoiding ghosting in the produced image and enhancing the processing quality in multi-light-source laser processing.

Further, the galvanometer parameter is a deflection angle of a galvanometer, and the deflection angle of the galvanometer of the laser processing device is reversely calibrated based on the first adjustment parameter or the second adjustment parameter.

In an optional embodiment, the deflection angle of the galvanometer may be reversely adjusted based on displacement data generated by a galvanometer operating controller.

In this embodiment, the displacement data indicating movement of the galvanometer is obtained, and the displacement data characterizes a difference between the galvanometer parameter in the first coordinate system and the galvanometer parameter in the predetermined image coordinate system when comparing the first coordinate system with the predetermined image coordinate system, so that a relative relationship between the first coordinate system and the predetermined image coordinate system is quickly obtained.

Further, each of the first pattern and the second pattern is divided into multiple regions to form an array, and a unit spacing of the multiple regions corresponds to an increment of the deflection angle of the galvanometer.

That is, the array including the multiple regions is determined based on the first pattern/second pattern, and the unit spacing of the multiple regions corresponds to the increment of the deflection angle of the galvanometer.

In other words, a difference between coordinate values is expressed as a difference between the regions of the array on the first pattern, and the difference between the regions is then converted into the adjustment parameter for calibrating the galvanometer.

In S141, the obtaining a first adjustment parameter based on the coordinate mapping relationship and the coordinate values of the first pattern in the first coordinate system includes the following steps S141a to S141b.

In S141a, a first coordinate difference is obtained based on the coordinate mapping relationship and the coordinate values of the first pattern in the first coordinate system, where the first coordinate difference has a proportional relationship with the unit spacing of the multiple regions.

In S141b, the adjustment parameter is obtained based on the first coordinate difference.

In S143, the obtaining a second adjustment parameter based on the coordinate mapping relationship and the coordinate values of the second pattern in the first coordinate system includes the following steps S143a to S143b.

In S143a, a second coordinate difference is obtained based on the coordinate mapping relationship and the coordinate values of the second pattern in the first coordinate system, where the second coordinate difference has a proportional relationship with the unit spacing of the multiple regions.

In S143b, the adjustment parameter is obtained based on the second coordinate difference.

In an embodiment, in a case that the first pattern is a rectangular pattern, a size of the first pattern is N×N, where N is an integer ranging from 5 to 50 and the value of N is determined according to the processing precision.

An N×N rectangular pattern is produced on the processing object by using the first light source, and an N×N rectangular pattern is produced on the processing object by using the second light source. A spacing between two adjacent rows or between two adjacent columns of the rectangular pattern, as well as the increment of the deflection angle of the galvanometer in the laser processing device are defined as: a maximum galvanometer deflection angle/N. For example, if a digital quantity of the maximum galvanometer deflection angle is 65536, each unit movement (for example, from a region located in the first row and the first column to a region located in the first row and the second column) correspondingly requires a deflection angle of 65536/N for the galvanometer when the laser processing device prints the N×N rectangular pattern. A region located in the first row and the first column of the rectangular pattern corresponds to a deflection angle of 0 (digital quantity: 0) for the galvanometer and a region located in the last row and the last column of the rectangular pattern corresponds to the maximum galvanometer deflection angle (digital quantity: 65536).

The first row may be the topmost row of the rectangular pattern, and the first column may be the leftmost column of the rectangular pattern. Correspondingly, the last row may be the bottommost row of the rectangular pattern, and the last column may be the rightmost column of the rectangular pattern.

Based on the above description, when producing by using the first light source, the proportional relationship between the first coordinate difference and the unit spacing of the rectangular pattern is determined and the deflection angle of the galvanometer is determined, to calibrate a processing position for the first light source.

When producing by using the second light source, the proportional relationship between the second coordinate difference and the unit spacing of the rectangular pattern is determined and the deflection angle of the galvanometer is determined, to calibrate a processing position for the second light source.

In an embodiment, the relative relationship between the actual coordinate system and the reference coordinate system is determined based on a relative relationship between coordinate values of an identical coordinate point, to adjust the deflection angle of the galvanometer.

For example, the first pattern is a rectangular pattern, and first positioning information includes positions of positioning points for establishing a coordinate system on the rectangular pattern.

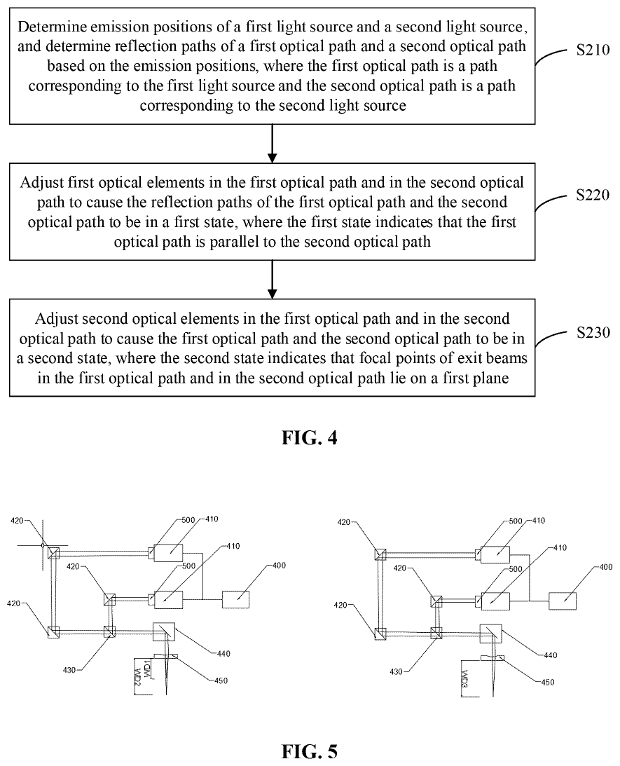

In an embodiment, FIG. 4 shows a schematic diagram of a multi-light-source calibration method according to an embodiment of the present disclosure. As shown in FIG. 4, the multi-light-source calibration method includes the following steps S210 to S230.

In S210, emission positions of a first light source and a second light source are determined, and reflection paths of a first optical path and a second optical path are determined based on the emission positions, where the first optical path is a path corresponding to the first light source and the second optical path is a path corresponding to the second light source.

In an embodiment, the emission positions of the first light source and the second light source are obtained based on mounting positions of laser emission components. When the laser emission components are mounted, the mounting positions are stored in a controller, so that the controller determines the emission positions of the first light source and the second light source based on the position information.

The emission positions of the first light source and the second light source are determined, and mounting positions of optical elements in the laser processing device are fixed. Therefore, after the emission positions of the first light source and the second light source are determined, the reflection paths of the first optical path and the second optical path can be determined based on the positions of the optical elements.

The first optical path is an optical path for the emission from the first light source. The reflection path of the first optical path refers to a path in which the emission of the first path passes through the optical elements and reaches a focal plane, which is represented in the form of an optical path.

The second optical path and the reflection path of the second optical path are defined in a similar way.

In S220, first optical elements in the first optical path and in the second optical path are adjusted to cause the reflection paths of the first optical path and the second optical path to be in a first state, where the first state indicates that the first optical path is parallel to the second optical path.

In an embodiment, states of the first optical path and the second optical path may be changed by adjusting states of the optical elements.

The reflection paths of the first optical path and the second optical path may exhibit multiple states, and different states may correspond to different parameters of the optical elements.

The first state indicates that the first optical path is parallel to the second optical path. In a case that the first optical path and the second optical path are parallel, focusing paths of the first optical path and the second optical path are aligned, and variables in the first optical path and the second optical path are reduced, to quickly adjust scanning areas and focal points based on parameters of the first optical path and the second optical path, thereby satisfying the requirement of multi-light-source laser processing.

In this embodiment, the first optical elements are adjusted to cause the reflection paths of the first optical path and the second optical path to be in the first state. The first state indicates that the first optical path is parallel to the second optical path.

When the first light source operates, a light spot state at a position in the first optical path is determined, and when the second light source operates, a light spot state at the same position in the second optical path is determined.

Based on the light spot states, it is determined that whether the first optical path is parallel to the second optical path.

In S230, second optical elements in the first optical path and in the second optical path are adjusted to cause the first optical path and the second optical path to be in a second state, where the second state indicates that focal points of exit beams in the first optical path and in the second optical path lie on a first plane.

After determining that the reflection paths of the first optical path and the second optical path are in the first state, the second optical elements are adjusted to cause the reflection paths of the first optical path and the second optical path to be in the second state.

In a case that the first optical path and the second optical path are simultaneously in the first state and the second state, it is indicated that the optical beams emitted from the first light source and the second light source are parallel in the reflection paths and the focal points in the two optical paths lie on the identical plane after the optical beams pass through the galvanometer.

For the first light source and the second light source, wavelengths are different and dispersion angles of emission elements are different. Thus, after the optical beams pass through a focusing element, the focal points in the first optical path and in the second optical path do not lie on the identical plane, that is, processing planes corresponding to the first optical path and the second optical path are different, which affects the display effect of the produced image and may result in ghosting or blurring.

Therefore, the second optical elements are adjusted to cause the focal points of the exit beams in the first optical path and the second optical path to lie on the identical plane.

In an embodiment, a focal point in one of the two optical paths is determined as a reference focal point, and only a beam parameter in the other optical path is required to be adjusted, so that a focal point in the other optical path, after passing through the focusing element, lies on the identical plane with the reference focal point.

FIG. 5 is a schematic diagram showing focal positions in the first optical path and in the second optical path.

The first optical path and the second optical path are respectively from lasers 410. The optical beams pass through beam expanders 500, reflectors 420, a dichroic mirror 430, a galvanometer 440, and a field lens 450, and then focus on planes, respectively.

As shown in FIG. 5, a working distance corresponding to the first optical path is WD1, a working distance corresponding to the second optical path is WD2, and the focal points in the first optical path and the second optical path do not lie on an identical plane.

After the above adjustment, as shown in the right diagram of FIG. 5, both the working distance corresponding to the first optical path and the working distance corresponding to the second optical path are WD3.

It should be noted that adjusting parameters of the second optical elements changes the working distances without changing the reflection paths for the optical paths. Due to the determinacy of the reflection paths, when the focal point in the first optical path and the focal point in the second optical path lie on the identical plane, they are actually located at an identical position on the identical plane.

A working distance refers to a distance between a focusing element and a focal plane in an optical path.

In this embodiment, emission positions of the first light source and the second light source are determined, and reflection paths of a first optical path and a second optical path are determined based on the emission positions. After controlling the reflection paths of the first optical path and the second optical path to be in a first state, second optical elements in the reflection paths of the first optical path and the second optical path are adjusted to cause the first optical path and the second optical path to be in a second state. The second state indicates that focal points of exit beams in the first optical path and in the second optical path lie on a first plane. A case that the focal points in the first optical path and in the second optical path both lie on the first plane indicates an identical processing plane for the first optical path and the second optical path. To enable an object to be processed based on both the first optical path and the second optical path, it is required to ensure that a scanning range of the first optical path is identical to a scanning range of the second optical path. The scanning range of the first optical path on the first plane is determined as a reference area. A galvanometer parameter is adjusted based on a size and position of the reference area to cause the scanning range of the second optical path on the first plane to be identical to the reference area, thereby implementing identical scanning areas for the first optical path and the second optical path. In this way, a processing object can be processed by multiple light sources without ghosting. When switching between different light sources, it is not required to recalibrate the focal points, thereby ensuring processing precision and enhancing processing quality in multi-light-source processing.

Further, a galvanometer is provided in the reflection paths, and after controlling the reflection paths of the first optical path and the second optical path to be in the first state or the second state, the multi-light-source calibration method further includes:

determining the scanning range of the first optical path on the first plane as the reference area, and adjusting the galvanometer parameter based on the reference area to cause the scanning range of the second optical path on the first plane to coincide with the reference area.

In an embodiment, after the focal points in the first optical path and in the second optical path are adjusted to be in the identical plane, the reference area is first determined, and then the galvanometer parameter is adjusted based on the reference area, so that the scanning range of the first optical path or the second optical path coincides with the reference area.

In an embodiment, the scanning range of the first optical path on the first plane is determined as the reference area.

The second light source is controlled to operate and emits an optical beam to form the second optical path. Then, the galvanometer parameter is adjusted to cause the galvanometer parameter to match the wavelength of the second light source and a beam diameter in the second optical path, so that the scanning range of the second optical path on the first plane coincides with the reference area.

In an optional embodiment, the determining a scanning range of the first optical path on the first plane as a reference area, and adjusting a galvanometer parameter of the galvanometer based on the reference area to cause a scanning range of the second optical path on the first plane to coincide with the reference area includes:
determining, based on a wavelength of the first light source and a current galvanometer parameter, the scanning range of the first optical path on the first plane as the reference area; and
adjusting the galvanometer parameter based on the reference area and a wavelength of the second light source, to cause the scanning range of the second optical path on the first plane to coincide with the reference area.

In an embodiment, the galvanometer parameter refers to an operational parameter of the galvanometer, such as a deflection angle or a reflection angle of the galvanometer. The galvanometer consists of two reflectors oriented along different axes, and a scanning range of a laser beam on a focal plane is determined based on reflection angles of the reflectors oriented along different axes.

In a case of identical scanning ranges for the two light sources, image blurring or ghosting are avoided during image processing, satisfying the usage requirement of multi-light-source processing and ensuring the processing quality in multi-light-source processing.

In an optional embodiment, the wavelength of the first light source is shorter than the wavelength of the second light source, and the adjusting the galvanometer parameter based on the reference area and a wavelength of the second light source, to cause the scanning range of the second optical path on the first plane to coincide with the reference area includes:
obtaining the scanning range of the first optical path on the first plane and the scanning range of the second optical path on the first plane under an identical galvanometer parameter; and
adjusting the galvanometer parameter during operation of the second light source based on a difference between the scanning range of the first optical path and the scanning range of the second optical path, to cause the scanning range of the second optical path on the first plane to coincide with the reference area.

A longer wavelength indicates a large scanning range on the focal plane. In an optional embodiment, the first light source may emit blue light and the second light source may emit infrared light.

In an embodiment, a scanning area with a smaller scanning range is determined as the reference area. Specifically, the scanning range of the first optical path and the scanning range of the second optical path are first obtained under the identical galvanometer parameter, and then the galvanometer parameter for the second optical path is reversely adjusted based on a difference between the scanning range of the first optical path and the scanning range of the second optical path, to cause the scanning range of the second optical path on the first plane to coincide with the reference area.

In this embodiment, the reference area is determined, and the galvanometer parameter is reversely adjusted based on the reference area and the difference between the scanning range of the first optical path and the scanning range of the second optical path, so that the scanning range of the other optical path is identical to the reference area. Targeted adjustment is performed on an optical path based on a relationship between the wavelength and the scanning range, achieving a rapid calibration of the scanning range.

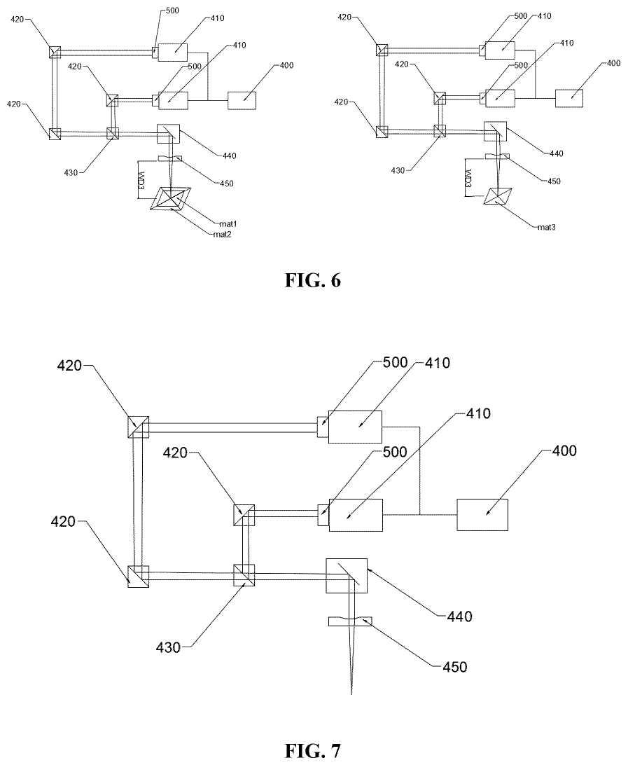

FIG. 6 is a schematic diagram showing the scanning ranges of the first optical path and the second optical path.

As shown in the left diagram of FIG. 6, the wavelengths of the first light source and the second light source are different, and thus the scanning ranges are different. The scanning range of the first optical path is mat1, and the scanning range of the second optical path is mat2. The scanning ranges of the first optical path and the second optical path are adjusted by the above method, so that the scanning ranges are identical, that is, the scanning ranges are mat3.

As shown in the right diagram of FIG. 6, after adjustment, the scanning ranges of both the first optical path and the second optical path are mat3.

It should be noted that the wavelengths of the first light source and the second light source are different, the deflection angles of the emitted beams are different, and the scanning ranges on the focal plane after the galvanometer are also different. To cause the scanning ranges of the first optical path and the second optical path to be identical, the galvanometer parameter corresponding to the first optical path is different from the galvanometer parameter corresponding to the second optical path.

In an optional embodiment, the first optical elements are reflectors.

Further, in S220, the adjusting first optical elements in the first optical path and the second optical path to cause the reflection paths of the first optical path and the second optical path to be in a first state includes:

adjusting an angle of a first reflector in the first optical path and an angle of a second reflector in the second optical path to cause the reflection paths, between a first position and a second position, of the first optical path and the second optical path to be in the first state.

In the reflection paths, a distance between the first position and an emission position of the first light source is less than a distance between the second position and the emission position of the first light source, and a distance between the first position and an emission position of the second light source is less than a distance between the second position and the emission position of the second light source.

The first position and the second position may be determined based on a specific position of a corresponding optical element in the laser processing device.

For example, when the corresponding optical element is a galvanometer, the first position may be located at a beam entrance aperture of the galvanometer and the second position may be located 500 mm away from the beam entrance aperture of the galvanometer.

In an optional embodiment, the second optical elements are beam expanders. Further, in S230, the adjusting second optical elements in the first optical path and the second optical path to cause the first optical path and the second optical path to be in a second state includes:
adjusting a divergence angle of a first beam expander in the first optical path to change a beam diameter in the first optical path after passing through a galvanometer, where the divergence angle of the first beam expander in the first optical path is adjusted based on the wavelength of the first light source, to change the beam diameter in the first optical path after passing through the galvanometer; and
adjusting a divergence angle of a second beam expander in the second optical path to change a beam diameter in the second optical path after passing through the galvanometer, where the divergence angle of the second beam expander in the second optical path is adjusted based on the wavelength of the second light source, to change the beam diameter in the second optical path after passing through the galvanometer.

In an optional embodiment, an optical parameter of the first beam expander is different from an optical parameter of the second beam expander.

According to a corresponding relation between a wavelength and a divergence angle of a beam expander, the beam diameter in the first optical path is adjusted based on the wavelength of the first light source and the beam expander, and the beam diameter in the second optical path is adjusted based on the wavelength of the second light source and the beam expander, so that focal planes are changed after the first optical path and the second optical path pass through the focusing element, and focal points of exit beams in the first optical path and the second optical path lie on the first plane.

A laser processing device is provided according to an embodiment of the present disclosure, which includes multiple processing light sources and a multi-light-source calibration apparatus. The multi-light-source calibration apparatus is configured to perform the multi-light-source calibration method provided according to the above embodiments.

In an embodiment, emissions from the processing light sources pass out lasers, and the number of the processing light sources may be more than one. The processing light sources are electrically connected to the multi-light-source calibration apparatus, and the multi-light-source calibration apparatus controls the switching of the processing light sources. The multi-light-source calibration apparatus is further configured to perform the multi-light-source calibration method provided according to the above embodiments.

FIG. 7 shows a schematic structural diagram of a numerical control device according to an embodiment of the present disclosure. As shown in FIG. 7, the numerical control device includes multiple lasers 410, multiple beam expanders 500, reflectors 420, a galvanometer 440, a field lens 450, and a control system 400.

The multiple lasers 410 are configured to emit optical beams.

The multiple beam expanders 500 are arranged at light-emitting ports of the multiple lasers 410 and configured to adjust beam diameters of the optical beams emitted from the multiple lasers 410.

The reflectors 420 are configured to reflect the optical beams emitted from the multiple lasers 410.

The galvanometer 440 is configured to reflect the optical beams reflected by the reflectors 420 onto scanning areas.

The field lens 450 is located below the galvanometer 440 and configured to focus the optical beams reflected by the galvanometer 440 onto a processing plane.

The control system 400 is electrically connected to the multiple lasers 410 and configured to control the numerical control device to perform the multi-light-source calibration method described above.

The control system 400 controls the multiple lasers 410 to emit laser beams and performs the multi-light-source calibration method provided according to the embodiments.

Further, the numerical control device includes a dichroic mirror 430. The dichroic mirror is configured to separate an optical beam to obtain a specific optical path, where an optical beam at a specific wavelength is completely transmitted and optical beams at other wavelengths are reflected with near-total efficiency.

The beam expanders 500 are mounted on the lasers 410 and are configured to change the beam diameters of the emitted laser beams.

The reflectors 420 are configured to reflect the optical beams emitted from the lasers 410 to focusing positions.

The galvanometer 440 is configured to reflect the optical beams onto scanning areas. The galvanometer 440 usually includes an x-scanning galvanometer 440 and a y-scanning galvanometer 440. A laser beam is reflected by the x-scanning galvanometer 440 to the y-scanning galvanometer 440, and these two galvanometers perform scanning motions along the x-axis and the y-axis respectively, thereby enabling deflection of the laser beam. The laser beam moves according to a predetermined pattern, implementing pattern scanning transformations and ultimately forming a processing pattern.

The field lens 450 usually refers to an F-Theta focusing lens, which is configured to focus the optical beams reflected by the galvanometer 440 onto a plane.

A computing system applied to laser processing is provided according to an embodiment. The computing system includes at least one numerical control device and at least one processor.

The at least one processor is configured to perform the multi-light-source calibration method provided according to the above embodiments.

The at least one numerical control device is configured to send a laser processing signal and adjust an optical path based on an instruction issued by the at least one processor.

A computer-readable storage medium is provided according to an embodiment. The computer-readable storage medium stores a program instruction. The program instruction is executed by a processor of an executable computer to perform the multi-light-source calibration method described above.

A computing system applied to laser processing is provided according to an embodiment. The computing system includes at least one processor, a computer-readable storage medium, and a program instruction stored on the computer-readable storage medium. The program instruction is executed by the at least one processor, and the computing system is configured to perform the multi-light-source calibration method according to the above embodiments.

Particularly, according to the embodiments of the present disclosure, processes described in flow charts of a method may be implemented as a computer software program. For example, according to an embodiment of the present disclosure, a computer program product including a computer program carried on a computer-readable medium is provided. The computer program includes program codes for performing the method shown in the flow chart. In such embodiment, the computer program may be downloaded and installed from a network via the communication portion, and/or may be installed from the removable medium. When the computer program is executed by the central processing unit, various functions defined in the system of the present disclosure are executed.

It should be noted that the computer-readable storage medium shown in the embodiments of the present disclosure may be a computer-readable signal medium and the like, including but not limited to a system, an apparatus, or a device in an electronic, magnetic, optical, electromagnetic, infrared, or semi-conductive form, or any combination thereof. A more specific example of the computer-readable storage medium may include but is not limited to: an electrical connection having one or more wires, a portable computer magnetic disk, a hard disk, a random access memory (RAM), a read-only memory (ROM), an erasable programmable read-only memory (EPROM), a flash memory, an optical fiber, a compact disk read-only memory (CD-ROM), an optical storage device, a magnetic storage device, or any appropriate combination thereof. In the present disclosure, the computer-readable storage medium may be any tangible medium including or storing a program, and the program may be used by or in combination with an instruction execution system, apparatus, or device. In the present disclosure, the computer-readable signal medium may be a data signal in a baseband or transmitted as a part of a carrier wave and carrying computer-readable program codes. The propagated data signal may be in various forms, including but not limited to an electromagnetic signal, an optical signal or any suitable combination thereof. Alternatively, the computer-readable signal medium may be any computer-readable medium other than the computer-readable storage medium. The computer-readable medium may send, propagate or transmit a program to be used by or in combination with an instruction execution system, apparatus or device. The program codes included in the computer-readable medium may be transmitted by using any suitable medium, including but not limited to, a wireless medium, a wire medium or the like, or any suitable combination thereof. The meaning of “first” and “second” in the above modules/units is only to distinguish different modules/units, and is not used to qualify which module/unit has a higher priority or other qualifying meanings. In addition, the terms “include”, “comprise”, and any variants thereof are intended to cover a non-exclusive inclusion. For example, a process, method, system, product, or device that includes a series of steps or modules is not limited to the steps or modules that are clearly listed, but may include other steps or modules that are not clearly listed or that are inherent to the process, method, product, or device. Division of the modules in the present disclosure is merely performed based on logic, and other division manners may be adopted during implementation in actual application.

Other embodiments of the present disclosure will be apparent to those skilled in the art from consideration of the specification and practice of the disclosure here. The present disclosure is intended to cover any variation, application, or adapted modification of the present disclosure. Such variation, application, or adapted modification follow the general principles of the present disclosure and include common knowledge or common technical means in the art which are not disclosed in the present disclosure.

The above embodiments are only used for illustrating the technical solutions of the present disclosure, and are not intended to limit the present disclosure. Although the present disclosure is illustrated in detail with reference to the embodiments described above, it should be understood by those skilled in the art that modification can be made to the technical solutions of the embodiments described above, or equivalent substitution can be made to a part of technical features of the technical solutions. Such modifications or substitutions do not cause the essence of corresponding technical solutions to depart from the spirit and scope of the technical solutions according to the embodiments of the present disclosure and shall fall within the protection scope of the present disclosure.

1. A multi-light-source calibration method, comprising:
producing a first pattern on a processing object by using a first light source, establishing a first coordinate system on the processing object, and determining coordinate values of the first pattern in the first coordinate system;
constructing a coordinate mapping relationship between the first coordinate system and a predetermined image coordinate system;
producing a second pattern on the processing object by using a second light source, and obtaining coordinate values of the second pattern in the first coordinate system; and
adjusting a galvanometer parameter of a laser processing device based on the coordinate mapping relationship, the coordinate values of the first pattern in the first coordinate system, and the coordinate values of the second pattern in the first coordinate system, to cause coordinate values of an identical image in an identical coordinate system to remain consistent when the identical image is produced separately by using the first light source and by using the second light source.

2. The multi-light-source calibration method according to claim 1, wherein the producing a first pattern on a processing object by using a first light source, establishing a first coordinate system on the processing object, and determining coordinate values of the first pattern in the first coordinate system comprises:
identifying a first positioning point and a second positioning point from the first pattern;
determining a third positioning point based on the first positioning point and the second positioning point, wherein the third positioning point is located on a straight line determined by the first positioning point and the second positioning point; and
generating the first coordinate system based on the first positioning point, the second positioning point, and the third positioning point, and determining the coordinate values of the first pattern in the first coordinate system,
wherein the generating the first coordinate system based on the first positioning point, the second positioning point, and the third positioning point, and determining the coordinate values of the first pattern in the first coordinate system comprises:
generating a first axis of the first coordinate system based on the first positioning point and the second positioning point;
generating, centered at the third positioning point, a second axis perpendicular to the first axis, and obtaining the first coordinate system based on the first axis and the second axis; and
determining the coordinate values of the first pattern in the first coordinate system based on the first coordinate system.

3. The multi-light-source calibration method according to claim 2, wherein the constructing a coordinate mapping relationship between the first coordinate system and a predetermined image coordinate system comprises:
obtaining coordinate values of the predetermined image coordinate system, and determining a difference between coordinate values of the first coordinate system and the coordinate values of the predetermined image coordinate system; and
constructing the coordinate mapping relationship between the first coordinate system and the predetermined image coordinate system based on the difference.

4. The multi-light-source calibration method according to claim 2, wherein the producing a second pattern on the processing object by using a second light source, and obtaining coordinate values of the second pattern in the first coordinate system comprises:
generating, by using the first light source, the first positioning point, the second positioning point, and the third positioning point on the second pattern;
generating the first coordinate system on the second pattern based on the first positioning point, the second positioning point, and the third positioning point; and
obtaining the coordinate values of the second pattern in the first coordinate system based on the first coordinate system.

5. The multi-light-source calibration method according to claim 1, wherein the obtaining coordinate values of the second pattern in the first coordinate system comprises:
obtaining the coordinate values of the second pattern in the first coordinate system via a visual acquisition tool.

6. The multi-light-source calibration method according to claim 1, wherein the adjusting a galvanometer parameter of a laser processing device based on the coordinate mapping relationship, the coordinate values of the first pattern in the first coordinate system, and the coordinate values of the second pattern in the first coordinate system comprises:
obtaining a first adjustment parameter based on the coordinate mapping relationship and the coordinate values of the first pattern in the first coordinate system;
obtaining a second adjustment parameter based on the coordinate mapping relationship and the coordinate values of the second pattern in the first coordinate system;
adjusting the galvanometer parameter of the laser processing device based on the first adjustment parameter when producing by using the first light source; and
adjusting the galvanometer parameter of the laser processing device based on the second adjustment parameter when producing by using the second light source.

7. The multi-light-source calibration method according to claim 6, wherein the galvanometer parameter is a deflection angle of a galvanometer, and the deflection angle of the galvanometer of the laser processing device is reversely calibrated based on the first adjustment parameter or the second adjustment parameter.

8. The multi-light-source calibration method according to claim 7, wherein each of the first pattern and the second pattern is divided into a plurality of regions to form an array, and a unit spacing of the plurality of regions corresponds to an increment of the deflection angle of the galvanometer, and
wherein the obtaining a first adjustment parameter based on the coordinate mapping relationship and the coordinate values of the first pattern in the first coordinate system comprises:
obtaining a first coordinate difference based on the coordinate mapping relationship and the coordinate values of the first pattern in the first coordinate system, the first coordinate difference having a proportional relationship with the unit spacing of the plurality of regions; and
obtaining the first adjustment parameter based on the first coordinate difference; and
the obtaining a second adjustment parameter based on the coordinate mapping relationship and the coordinate values of the second pattern in the first coordinate system comprises:
obtaining a second coordinate difference based on the coordinate mapping relationship and the coordinate values of the second pattern in the first coordinate system, the second coordinate difference having a proportional relationship with the unit spacing of the plurality of regions; and
obtaining the second adjustment parameter based on the second coordinate difference.

9. A multi-light-source calibration method, comprising:
determining emission positions of a first light source and a second light source, and determining reflection paths of a first optical path and a second optical path based on the emission positions, wherein the first optical path is a path corresponding to the first light source and the second optical path is a path corresponding to the second light source;
adjusting first optical elements in the first optical path and in the second optical path to cause the reflection paths of the first optical path and the second optical path to be in a first state, wherein the first state indicates that the first optical path is parallel to the second optical path; and
adjusting second optical elements in the first optical path and in the second optical path to cause the first optical path and the second optical path to be in a second state, wherein the second state indicates that focal points of exit beams in the first optical path and in the second optical path lie on a first plane.

10. The multi-light-source calibration method according to claim 9, wherein a galvanometer is provided in the reflection paths, and after controlling the reflection paths of the first optical path and the second optical path to be in the first state or the second state, the multi-light-source calibration method further comprises:
determining a scanning range of the first optical path on the first plane as a reference area, and adjusting a galvanometer parameter of the galvanometer based on the reference area to cause a scanning range of the second optical path on the first plane to coincide with the reference area.

11. The multi-light-source calibration method according to claim 9, wherein the first optical elements are reflectors, and the adjusting first optical elements in the first optical path and in the second optical path to cause the reflection paths of the first optical path and the second optical path to be in a first state comprises:
adjusting an angle of a first reflector in the first optical path and an angle of a second reflector in the second optical path to cause the reflection paths, between a first position and a second position, of the first optical path and the second optical path to be in the first state.

12. The multi-light-source calibration method according to claim 11, wherein in the reflection paths, a distance between the first position and an emission position of the first light source is less than a distance between the second position and the emission position of the first light source, and a distance between the first position and an emission position of the second light source is less than a distance between the second position and the emission position of the second light source.

13. The multi-light-source calibration method according to claim 9, wherein the second optical elements are beam expanders, and the adjusting second optical elements in the first optical path and in the second optical path to cause the first optical path and the second optical path to be in a second state comprises:
adjusting a divergence angle of a first beam expander in the first optical path based on a wavelength of the first light source, to change a beam diameter in the first optical path after passing through a galvanometer; and
adjusting a divergence angle of a second beam expander in the second optical path based on a wavelength of the second light source, to change a beam diameter in the second optical path after passing through the galvanometer.

14. The multi-light-source calibration method according to claim 13, wherein an optical parameter of the first beam expander is different from an optical parameter of the second beam expander.

15. The multi-light-source calibration method according to claim 10, wherein the determining a scanning range of the first optical path on the first plane as a reference area, and adjusting a galvanometer parameter of the galvanometer based on the reference area to cause a scanning range of the second optical path on the first plane to coincide with the reference area comprises:
determining, based on a wavelength of the first light source and a current galvanometer parameter, the scanning range of the first optical path on the first plane as the reference area; and
adjusting the galvanometer parameter based on the reference area and a wavelength of the second light source, to cause the scanning range of the second optical path on the first plane to coincide with the reference area.

16. The multi-light-source calibration method according to claim 15, wherein the adjusting the galvanometer parameter based on the reference area and a wavelength of the second light source, to cause the scanning range of the second optical path on the first plane to coincide with the reference area comprises:
obtaining the scanning range of the first optical path on the first plane and the scanning range of the second optical path on the first plane under an identical galvanometer parameter; and
adjusting the galvanometer parameter during operation of the second light source based on a difference between the scanning range of the first optical path and the scanning range of the second optical path, to cause the scanning range of the second optical path on the first plane to coincide with the reference area.

17. A numerical control device, comprising:
a plurality of lasers, configured to emit optical beams;
a plurality of beam expanders, arranged at light-emitting ports of the plurality of lasers, and configured to adjust beam diameters of the optical beams emitted from the plurality of lasers;
reflectors, configured to reflect the optical beams emitted from the plurality of lasers;
a galvanometer, configured to reflect the optical beams reflected by the reflectors onto, scanning areas;
a field lens, located below the galvanometer, and configured to focus the optical beams reflected by the galvanometer onto a processing plane; and
a control system, electrically connected to the plurality of lasers, and configured to control the numerical control device to perform the multi-light-source calibration method according to claim 9.

18. A laser processing device, comprising:
a plurality of processing light sources; and
a multi-light-source calibration apparatus, configured to perform the multi-light-source calibration method according to claim 1.

19. A computing system, applied to laser processing, wherein the computing system comprises:
at least one numerical control device;
at least one processor;
at least one non-transitory computer-readable medium; and
program instructions stored on the at least one non-transitory computer-readable medium, wherein
the program instructions, when executed by the at least one processor, cause the computing system to perform the multi-light-source calibration method according to claim 1, and
the at least one numerical control device is configured to send a laser processing signal and adjust an optical path based on an instruction issued by the at least one processor.

20. A non-transitory computer-readable storage medium, storing program instructions, wherein the program instructions are executed by a processor to perform the multi-light-source calibration method according to claim 1.
